(19) United States
(12) Patent Application Publication
(10) Pub. No.: US 2025/0298985 A1
(43) Pub. Date: Sep. 25, 2025

(54) COMMUNICATION ANALYSIS USING LARGE LANGUAGE MODELS

(71) Applicant: Zoom Video Communications, Inc., San Jose, CA (US)

(72) Inventors: Davide Giovanardi, San Jose, CA (US); Bilung Lee, Irvine, CA (US); Xiaoli Song, Redding, CA (US)

(73) Assignee: Zoom Video Communications, Inc., San Jose, CA (US)

(21) Appl. No.: 18/610,801

(22) Filed: Mar. 20, 2024

(51) Int. Cl. G06F 40/35

(52) U.S. Cl. CPC G06F 40/35

(57) ABSTRACT

One example method for communication analysis using LLMs includes receiving a set of communication records, the set of communication records representing one or more communications between a first person and a second person; receiving a set of analytical parameters associated with the set of communication records; generating a plurality of segments from the communication records; for each analytical parameter in the set of analytical parameters: determining a subset of segments semantically associated with the respective analytical parameter; generating, using a trained large language model (“LLM”), an evaluation of each segment of the respective subset of segments with respect to the respective analytical parameter; and generating, using the trained LLM, a response to the analytical parameter based on the evaluations of the segments; and outputting a full evaluation of the set of communication records based on the set of analytical parameters and the respective generated responses to the analytical parameters.

### FIELD

The present application generally relates to large language models (“LLMs”) and more particularly relates to communication analysis using LLMs.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for communication analysis using LLMs;

FIGS. 3A-3B show an example system for communication analysis using LLMs;

FIG. 4 shows an example system for communication analysis using LLMs;

FIG. 5 shows an example for method communication analysis using LLMs; and

FIG. 6 shows an example computing device suitable for use with example systems and methods for communication analysis using LLMs.

### DETAILED DESCRIPTION

Examples are described herein in the context of communication analysis using LLMs. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

In modern life, people frequently interact using electronic devices, such as by chat messaging, one-on-one phone calls, or virtual conferences, such as video or telephone conferences. In many cases, such communication channels may be hosted by a virtual conference provider, even in the case of one-on-one phone calls or chat messages. Virtual conference providers may provide enhancements of some of these channels by providing transcripts of a conversation or a conference, either in real-time or after the conclusion of the conference. Real-time transcripts can assist participants who may have difficulty hearing or who do not speak the language(s) used by other participants in the conference. Transcripts can also be used after a conference to review the details of the discussion, which may provide action items or important information to guide work on a project. In some cases, participants may use transcripts of past conferences to prepare for an upcoming conference, such as to recall information discussed during the meeting. In addition to virtual conferences, however, people may communicate through other communication channels, such as chat channels and emails. All of these disparate communications may relate to the same topic project, such as a technical support question or a potential sales opportunity.

After the issue under discussion is completed, or potentially while the discussion is on-going, it may be important to a person involved in the discussion to obtain feedback regarding their performance, such as whether they are providing relevant information, whether they are responding to questions that have been asked or are highlighting important details. At a coarse level, it may be possible to evaluate performance based on the outcome of a discussion, such as whether a sale was successful or not or whether a technical issue was resolved within a certain period of time. However, such feedback may not address the details of the conversations between the various parties and provide indications of whether particular utterances or threads of discussion were productive or not.

To help provide fine-grained analysis of communications between people, the content of those communications can be captured, such as through transcripts of virtual conferences, chat logs, and email chains. The data from these communications can then be segmented into smaller pieces and used to generate corresponding embeddings, or numeric representations of those segments. In addition, analytical parameters, such as targeted evaluative questions about the substance discussed may also be used to generate additional embeddings that can be used to identify semantic relationships between the evaluative questions and the segments of the communications.

For each of the analytical parameters, one or more corresponding segments may be identified and provided to a large language model to evaluate the quality of the segment(s) with respect to the particular analytical parameter. For example, a prompt may be generated and provided to the LLM to request that it provide an evaluation of the analytical parameter and the respective segment. Once the evaluations have been generated, all of the evaluations associated with a particular analytical parameter may then be provided to the LLM to generate an overarching evaluation of the communication with respect to the analytical parameter. In addition, the LLM may be instructed to provide a justification for the evaluation of the communication. This process can be repeated for each analytical parameter provided to the system, such as a series of evaluative questions. Once evaluations and, optionally, justifications for those evaluations have been generated, they can be provided as feedback to the person involved in the communication. In some examples, this process may be performed in near-real time, e.g., following a virtual conference or after an email exchange. In other examples, it may be performed after the entire discussion has completed.

Such a system can analyze the communications between two or more people and provide fine-grained feedback to one or more of the individuals based on the content of the communications over time. Moreover, this can enable a person to more efficiently or effectively engage in future discussions regarding similar topics.

This illustrative example is given to introduce the reader to the general subject matter discussed herein and the disclosure is not limited to this example. The following sections describe various additional non-limiting examples and examples of communication analysis using large language models.

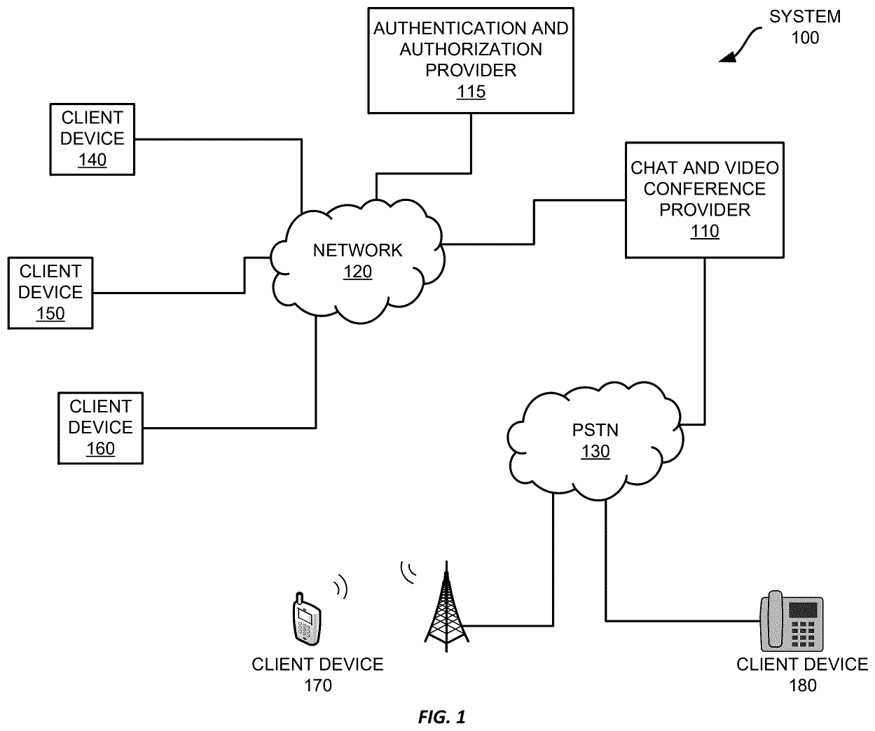

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

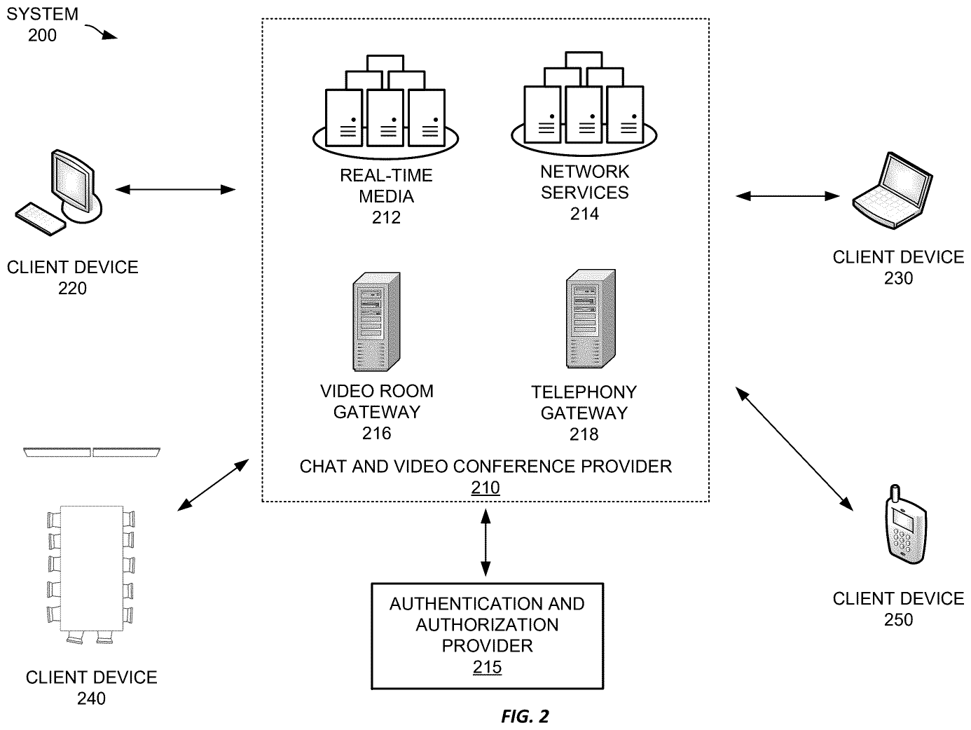

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized

authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

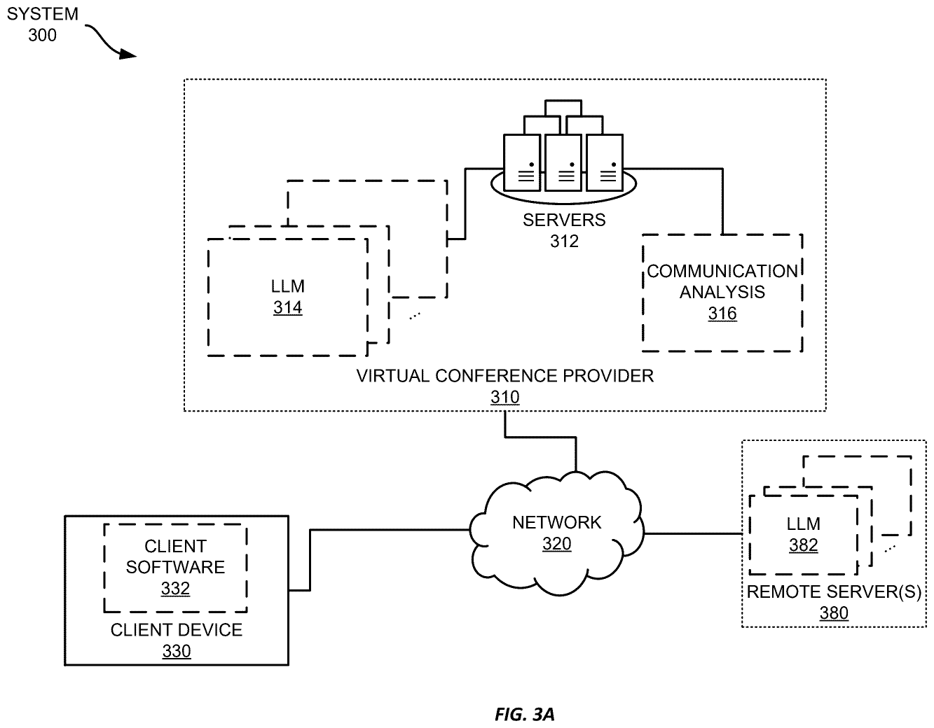

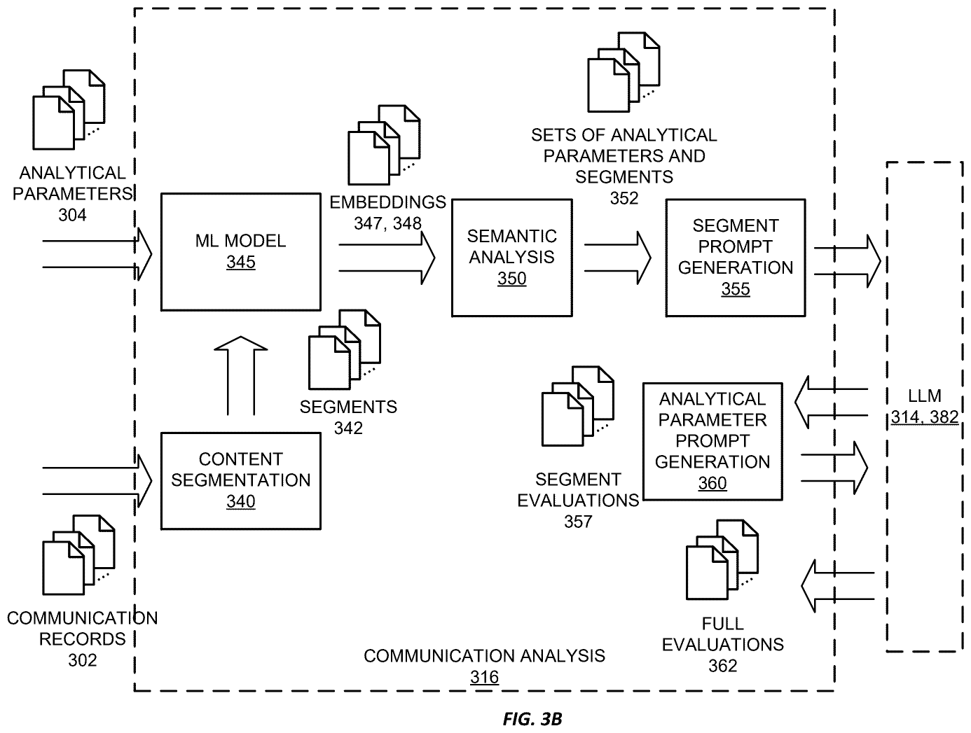

Referring now to FIGS. 3A-3B, FIG. 3A shows an example system 300 for communication analysis using LLMs. In this example, the system 300 includes a client device 330, a virtual conference provider 310, and one or more remote servers 380 that host one or more LLMs 382. In this example, the virtual conference provider 310 provides chat and virtual conferencing capabilities, such as discussed above with respect to FIGS. 1-2, but also provides one or more servers 312 that provide one or more LLMs 314 that may be used to service requests received from users via their respective client device, such as client device 330. In addition, the virtual conference provider 310 provides communication analysis functionality 316 to analyze user communications and provide corresponding feedback.

The LLM 314 may be a model that has been trained on a large corpus of data, such as information available from licensed, commercially usable, non-public datasets. For LLMs, the training data may be written materials, such as webpages, documents, emails, or blogs that may be relevant to generating written works.

Examples of LLMs include GPT models of different versions, autoregressive LLMs (e.g., Large Language Model Meta A (LLAMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

Client devices may execute client software 332 to join and participate in virtual conferences hosted by the virtual conference provider 310. During a virtual conference, the participants can exchange audio and video streams, as discussed above with respect to FIGS. 1-2, to interact with each other, discuss any topics of interest, and share content. Similarly, the participants can continue any discussions outside of a virtual conference, such as by using chat functionality provided by the virtual conference provider. They may also email each other using email services provided by the virtual conference provider 310 or another third party.

Over the course of a multiple discussions about a common topic, such as a technical support issue or a sales opportunity, one or more of the participants may wish to receive feedback about their performance during the discussions. For example, a salesperson or their supervisor may wish to obtain feedback about their performance. Even if the sales opportunity is ultimate successful, there may be opportunities to improve performance and achieve a better chance of successful sales in the future.

To do so, the virtual conference provider 310 can access communications associated with the topic of discussion. The communications may be reflected in transcripts generated from virtual conferences or phone calls, chat messages, emails, instant messages, or any other form of communication. For spoken communication, such as during a virtual conference or phone call, the virtual conference provider may generate a corresponding textual representation by using suitable automatic speech recognition (“ASR”) functionality. The participant or their supervisor may provide access to emails, chat channels, and conversation transcripts to the virtual conference provider along with one or more analytical parameters that may be used to evaluate different portions of the communication.

In this example, a salesperson's supervisor has developed an evaluation questionnaire designed to probe various aspects of the various conversations held between the salesperson and the potential customer. The questionnaire may include multiple different questions that call for different types of answers. For example, one question may ask whether the salesperson tied particular feature functionality to a particular business need of the potential customer and include a prompt for a “yes” or “no” response. Other questions may seek other types of responses, such as multiple choice responses, a numerical rating (e.g., from 1 to 5), or a free-formed textual response.

The questionnaire and the various communications records can be provided to a trained machine learning (“ML”) model, such as a LLM to analyze the communications records with respect to the various questions in the questionnaire and the types of responses requested. However, LLMs are not generally equipped to handle queries of this nature. For example, LLMs typically have limited input sizes that preclude providing large volumes of text input. In addition, providing multiple questions and a number of disparate communications records may elicit unfocused or inaccurate responses from the LLM, or may result in individual responses addressing multiple questions or ignoring many of the questions.

Thus, the virtual conference provider 310 employs a process for communication analysis that segments the communications records and generates binary (non-textual) representations of the segments for further analysis. By segmenting the communications records and analyzing the segments, the virtual conference provider can employ an LLM to provide evaluation feedback based on the communications records and any provided analytical parameters.

Referring now to FIG. 3B, FIG. 3B illustrates an example of communication analysis functionality 316 provided by the virtual conference provider 310. The communication analysis functionality 316 receives textual communication records 312 and corresponding analytical parameters 312 to perform communication analysis. As discussed above, communication records may be any textual form of communication, such as chat messages, emails, instant messages, or the like. In addition, textual representations of verbal communications may be used as well, such as transcripts of virtual conferences or telephone calls.

The analytical parameters represent textual evaluation criteria for the communication records. The analysis parameters may be questions, statements, or other criteria that can be applied semantically to the communication records to determine an evaluation of at least a portion of the discussion represented by the communication records. In this example, the analytical parameters comprise a plurality of questions associated with the communications records. In addition, the analytical parameters may include definitions of evaluation formats for the analytical parameters, such as binary evaluations (e.g., “yes” or “no,” “acceptable” or “unacceptable”), a range for a numerical rating, a set of predefined responses (e.g., multiple choice answers), or an indication of a free-form textual response. It should be appreciated that each analytical parameter may have a different evaluation format.

As discussed above, communication records 302 may be lengthy textual records. Transcripts from virtual conferences, emails, and chat records all may include large quantities of text that cannot be employed directly with an LLM 314, 382. Thus, the communication analysis functionality 316 performs content segmentation 340 on the received communication records. In this example, the content segmentation functionality 340 breaks the communication records 302 into segments based on sentences. Thus, each sentence is output as a separate segment. Phrases that are not complete sentences, e.g., short responses in a chat channel, are similarly output as segments in this example.

Once the segments have been generated, the communication analysis functionality 316 determines semantic relationships between the segments and the analytical parameters 304. In this example, to perform the semantic analysis 350, the communication analysis functionality 316 first employs a trained ML model, such as a trained autoencoder, a trained predictor model, or any other variety of trained neural network, to generate binary embeddings 347, 348 for each of the analytical parameters 347 and for each segment 348. The binary embeddings 347, 348 are then provided for semantic analysis 350. In this example, the semantic analysis functionality 350 analyzes each analytical parameter embedding against each content segment embedding to determine a similarity score for the embeddings. If the similarity score satisfies a predetermined threshold, the segment is determined to be semantically related to the analytical parameter. Otherwise, the segment is determined to be not semantically related to the analytical parameter. Through this process, each analytical parameter is associated with one or more content segments.

While the example shown in FIG. 3B employs binary embeddings, other techniques may be used to determine semantic relationships between content segments 342 and analytical parameters 304. For example, rather than generating binary embeddings using a trained ML model 345, as discussed above, a cross-encoder may be provided with textual inputs representing an analytical parameter and a content segment 342. The cross-encoder compares the two textual inputs to determine a similarity between them and outputs a score indicating the level of similarity, e.g., a value between 0 and 1. Thus, the semantic analysis functionality 350 could employ such a technique to identify segments that are sufficiently semantically related to the corresponding analytical parameter, e.g., the similarity score satisfies a threshold such as 80% or 90%. After analyzing each analytical parameter against all of the content segments, a set of semantically related content segments can be generated for each analytical parameter. And while these techniques represent some ways to determine semantic similarity between analytical parameters and content segments, others may be used. For example, the semantic analysis functionality 350 may employ an LLM to analyze or score the similarity between analytical parameters and content segments 342.

It should be appreciated that in some examples, a single content segment may be associated with multiple analytical parameters. Moreover, depending on the content of the communication records, one or more analytical parameters may not have any associated segments. In addition, for a particular set of communication records, an analytical parameter may be associated with a large number of segments following semantic analysis 350. To help reduce the processing burden, a predetermined maximum number of segments may be associated with each analytical parameter. For example, the content segments 342 having the ten highest similarity scores may be associated with the analytical parameter and the remaining associated content segments 342 may be discarded for that analytical parameter. In some examples, content segments that do not satisfy a similarity threshold may be excluded, with any that do satisfy the threshold may be associated with the analytical parameter.

Once the sets of analytical parameters and associated content segments have been generated as discussed above, the communication analysis functionality 316 employs segment prompt generation functionality 355 to generate prompts to submit an analytical parameter and an associated content segment to an LLM 314, 382 to generate an evaluation of the segment. In this example, the segment prompt generation functionality 355 generates a prompt requesting that the LLM evaluate the content segment based on the associated analytical parameter and to generate an evaluation based on the evaluation format for the analytical parameter. In some examples, the segment prompt generation functionality 355 may also include an instruction to generate a justification for the evaluation. For example, the segment prompt generation functionality 355 may generate a prompt according to a predefined template, such as according to the following format: “Evaluate how well [content segment] satisfies [analytical parameter] according to [evaluation format]. Please also provide a justification for the evaluation.” The segment prompt generation functionality 355 may then provide the prompt to the LLM 314, 382 to evaluate. Further, it may repeat this process for each analytical parameter and for each segment of each analytical parameter to generate corresponding evaluations of each. In cases where an analytical parameter does not have any associated segments, the segment prompt generation may skip the analytical parameter.

After providing a prompt to the LLM 314, 382, the LLM 314, 382 generates a segment evaluation 357, which is received and stored by the communication analysis functionality 316. After segment evaluations have been generated for all prompts provided to the LLM 314, 382, the communication analysis functionality employs analytical parameter prompt generation functionality 360 to generate a prompt to the LLM 314, 382 to generate a full evaluation of the analytical parameter based on all of the segment evaluations 357. In this example, similar to the segment prompt generation functionality 355, the segment prompt generation functionality 360 generates a prompt based on a template, such as “Generate an evaluation of [analytical parameter] based on [set of segment evaluations] and provide the evaluation using [evaluation format].” In examples where the segment prompt generation functionality 355 included an instruction to generate a justification, the analytical parameter prompt generation functionality 360 may also generate a prompt to generate an overall justification for the full evaluation: Generate an evaluation of [analytical parameter] based on [set of segment evaluations] and provide the evaluation using [evaluation format]. Also generate a justification for the evaluation.” The LLM 314, 382 then generates a full evaluation 362 for the respective analytical parameter. By submitting each of the analytical parameters along with the corresponding segment evaluations, a set of full evaluations 362 is generated.

And while this example employs an LLM to generate the set of full evaluations, in some examples, the communications analysis functionality 316 may use other techniques. For example, the communication analysis functionality 316 may employ a max pooling technique (or min-pooling technique) to select the best (or worst) segment evaluation. For segment evaluations that have numerical rating, a highest (or lowest) rating may be selected. Such an example may be employed in scenarios where an analytical parameter is expected to have a single segment that provides the corresponding information. In other examples, the communication analysis functionality 316 may use a mean-pooing technique to generate an average evaluation based on the segment evaluations, or based on segment evaluations that satisfy a predefined threshold. It should be appreciated that different techniques may be applied to different analytical parameters within a single set of analytical parameters. Thus, max pooling may be employed for a first analytical parameter, while mean pooling may be employed for a second analytical parameter, and an LLM may be employed for a third analytical parameter. Thus, the communication analysis functionality 316 can dynamically select an appropriate evaluation technique for an analytical parameter, such as based on the analytical parameter itself or based on the associated segment evaluations 357.

After generating a set of full evaluations and, optionally, justifications, for the analytical parameters, the full evaluations and justifications may be provided to the user who requested the evaluation.

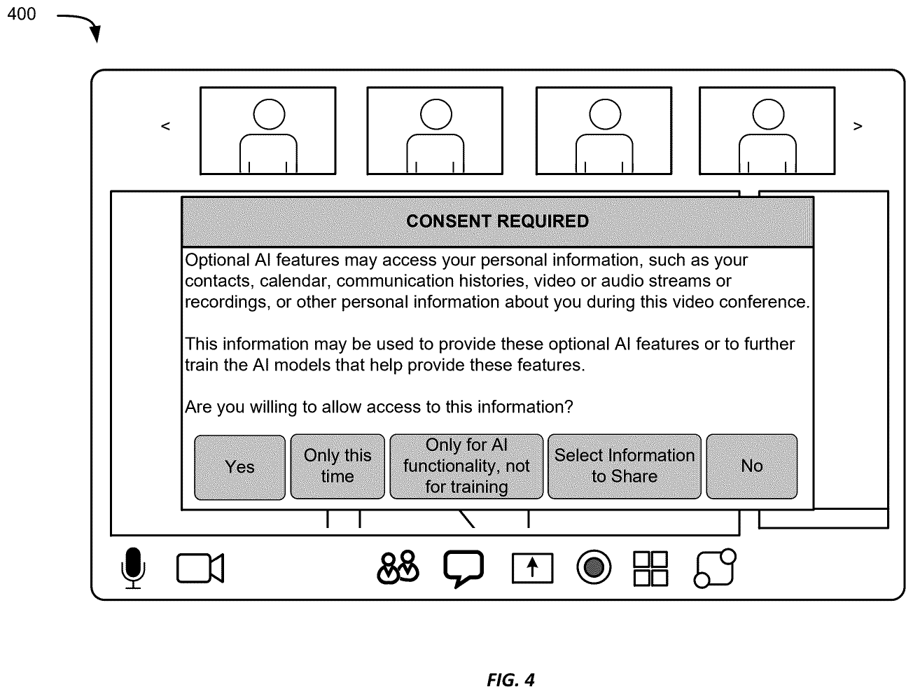

Referring now to FIG. 4, FIG. 4 shows a GUI 400 presenting a consent option to employ certain AI-assisted features. In some examples according to the present disclosure, a user may select an option to use one or more optional AI features available from the virtual conference provider, such as ASR functionality or to train that ASR functionality as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 4, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

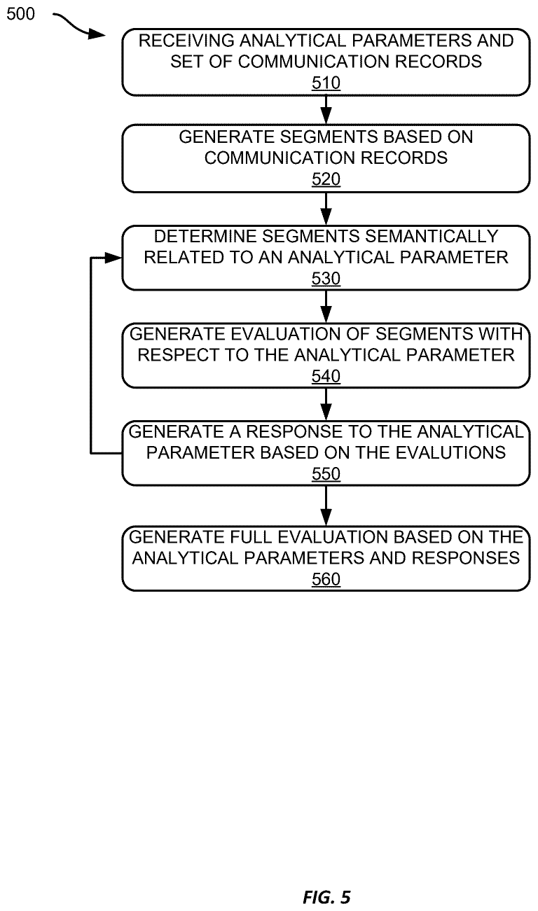

Referring now to FIG. 5, FIG. 5 shows an example method 500 for communication analysis using LLMs. The method 500 of FIG. 5 will be discussed with respect to the example system 300 shown in FIGS. 3A-3B; however, any suitable system according to this disclosure may be employed. It should be appreciated that while FIG. 5 is described with respect to a communication analysis functionality 316 executed by a virtual conference provider, the communication analysis functionality 316 may be executed by any suitable computing device, including a client device 330 (e.g., as a part of client software 332) or a remote server 380.

At block 510, the communication analysis functionality 316 receives a set of analytical parameters 304 and a set of communication records 302, generally as discussed above with respect to FIG. 3B. In this example, the set of communication records 302 includes transcripts from video conferences or phone calls, chat communications from a chat channel or direct messages, email messages, text or short message service (“SMS”) messages, shared documents, or any other written record associated with communications between two or more people. The information may be received from any resource, such as a data store maintained by the virtual conference provider or other server. In some examples, the information may be received from a user, such as by providing email messages from their inbox or information from their calendar.

In this example, the set of analytical parameters 304 includes a set of evaluative questions, such as “did the seller tie the feature functionality to the business outcomes that matter most to the prospect” or “on a scale of 1 to 5, how well did the seller tie the feature functionality to the business outcomes that matter most to the prospect?” However, other types of analytical parameters may be employed. For example, analytical parameters may be commands to execute over the set of communication records, such as “identify all of the references to beneficial features of the product” or “identify the top three reasons given for why the product would be ideal for the customer.” Other types of analytical parameters may be requests to identify missing information or number of different communications between the participants, such as “which of the following features did the seller discuss with the customer: X, Y, and Z” or “how many phone calls or video conferences involved discussing a potential product sale?” Still other types of analytical parameters may be employed.

At block 520, the communication analysis functionality 316 generates a plurality of segments 342 from the communication records 302. In this example, the content segmentation functionality 340 generates a segment 342 for each sentence in each communication record 302. For groups of words that do not form a complete sentence, such as in the case of a meeting title or a brief chat message, the content segmentation functionality 340 may generate a single segment 342 for each such group of words. In other examples, the content segmentation functionality 340 may generate segments 342 according to other criteria, such as based on paragraphs of text in a written document. For transcripts, a segment 342 may be a single continuous portion of the transcript associated with a single speaker. Thus, each time a new speaker speaks, a new segment 342 may be generated. In some examples, segments 342 may be generated based on semantic relationships between sentences in a document or written communication or utterances within a transcript from a particular person.

At block 530, the communication analysis functionality 316 determines a subset of segments semantically related to one of the analytical parameters. In this example, the communication analysis functionality 316 employs a trained ML model to generate embeddings 347, 348 for each of the segments 342 and for each of the analytical parameters 304. After generating the embeddings 347, 348, the embeddings are provided to the semantic analysis functionality 350 to identify similarities between analytical parameter embeddings 347 and segment embeddings 348. Thus, for each analytical parameter embedding 347, the semantic analysis functionality 350 determines a similarity between the two embeddings 347, 348. For example, the similarity may be a real value between 0 and 1 (or any other bounded range) or a value within a partially or totally unbounded range. In some examples, the similarity may be binary value of either similar or not similar. Thus, for each analytical parameter embedding a set of similarities may be generated.

The communication analysis functionality 316 then identifies segment embeddings 348 that are semantically related to the analytical parameter embedding 347. In this example, the communication analysis functionality selects content embeddings 348 with similarities above a predetermined threshold, e.g., 0.95 (on a scale from 0 to 1). Thus, all content embeddings 348 with a similarity of 0.95 or greater is determined to be semantically related to the corresponding analytical parameter embedding 347. In some examples, the communication analysis functionality 316 may only select a predetermined number of content embeddings 348, rather than all content embeddings 348 whose similarity satisfies the predetermined threshold, e.g., it may select only the top ten content embeddings 348. In some examples, if a threshold number of content embedding 348 has not been identified, e.g., the communication analysis functionality 316 selects the top ten content embeddings 348, but only six satisfy the similarity threshold, the communication analysis functionality 316 may relax the similarity threshold to obtain additional semantically related content embeddings 348. In some such examples, the similarity threshold may only be relaxed by a maximum of a predetermined amount, e.g., a minimum threshold of 0.8 or a maximum relaxation of 0.1 or a maximum relaxation percentage of 15%.

And while this example employs embeddings 347, 348, other examples may perform semantic analysis using other techniques. For example, the communication analysis functionality 316 may ask the LLM 314, 382 to provide a similarity for each segment 342 for a given analytical parameter 304. The similarities for the segments may be then employed as discussed above. In some examples, other techniques may be employed. For example, a cross-encoder may be provided with textual inputs representing an analytical parameter and a content segment 342, as discussed above with respect to FIG. 3B. The cross-encoder compares the two textual inputs to determine a similarity between them and outputs a score indicating the level of similarity. The similarities may then be used as discussed above.

At block 540, the communication analysis functionality 316 generates an evaluation of each semantically related segment with respect to the analytical parameter 304. In this example, the sets of analytical parameters and semantically related segments 352 are provided to the segment prompt generation functionality 355, which operates generally as discussed above with respect to FIG. 3B. The generated prompts are then provided to the LLM 314, 382, which generates an evaluation for each semantically related content segment with respect to the analytical parameter, generally as discussed above with respect to FIG. 3B.

At block 550, the communication analysis functionality 316 generates a response to the analytical parameter, including optionally generating a justification for the response, based on the evaluations of the semantically related content segments, generally as discussed above with respect to FIG. 3B.

The communication analysis functionality 316 then determines if all analytical parameters have been evaluated. If any remain, the method 500 returns to block 530 to process the next analytical parameter. And while the method 500 is depicted as operating sequentially, it should be appreciated that each individual block may be performed for each analytical parameter before proceeding to the next block such that the method does not return to block 530 after proceeding to block 540.

At block 560, the communication analysis functionality 316 generates a full evaluation of the set of communication records based on the responses and, optionally the justifications generated through the iterations of the method 500 for the various analytical parameters 304 and semantically related segments 342.

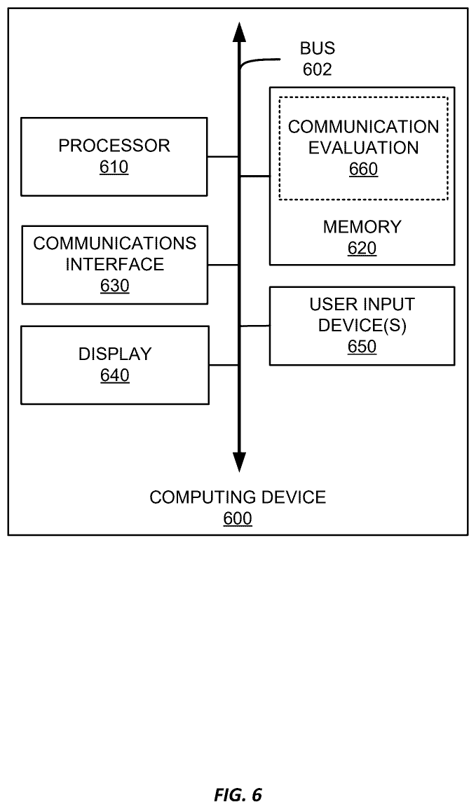

Referring now to FIG. 6, FIG. 6 shows an example computing device 600 suitable for use in example systems or methods for communication analysis using LLMs according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for communication analysis using LLMs according to different examples, such as part or all of the example method 500 described above with respect to FIG. 5. Suitable example computing devices 600, such as user client devices, may also include one or more user input devices 650, such as a keyboard, mouse, touchscreen, microphone, etc., to accept user input. The computing device 600 also includes a display 640 to provide visual output to a user. In addition, the computing device 600 includes communication analysis functionality 660, such as discussed above with respect to FIGS. 3A-3B.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a set of communication records, the set of communication records representing one or more communications between a first person and a second person;
receiving a set of analytical parameters associated with the set of communication records;
generating a plurality of segments from the communication records;
for each analytical parameter in the set of analytical parameters:
determining a subset of segments semantically associated with the respective analytical parameter;
generating, using a trained large language model (“LLM”), an evaluation of each segment of the respective subset of segments with respect to the respective analytical parameter; and
generating, using the trained LLM, a response to the analytical parameter based on the evaluations of the segments; and
outputting a full evaluation of the set of communication records based on the set of analytical parameters and the respective generated responses to the analytical parameters.

2. The method of claim 1, further comprising:
generating, using a trained machine learning (“ML”) model, analytical parameter embeddings for each analytical parameter of the set of analytical parameters;
generating, using the trained ML model, segment embeddings for each segment of the plurality of segments; and
wherein determining the subset of segments semantically associated with the respective analytical parameter is based on the respective analytical parameter embedding and the segment embeddings.

3. The method of claim 1, wherein generating the response to the analytical parameter comprises generating, using the trained LLM, a justification associated with the response to the analytical parameter.

4. The method of claim 1, further comprising:
generating, for each analytical parameter and associated segment of the respective subset of segments, a prompt for the LLM, the prompt comprising the analytical parameter, the segment, and an indication of an evaluation format to be generated;
providing the prompt to the LLM; and
wherein generating the respective evaluation of each segment is based on the prompt.

5. The method of claim 4, wherein the evaluation format comprises one of (a) a “yes” or “no” answer, (b) a selection from multiple choices, (c) a numerical rating, or (d) a free-form answer.

6. The method of claim 1, wherein determining the subset of segments semantically associated with the respective analytical parameter comprises:
for each analytical parameter:
for each segment:
providing, to a cross-encoder for each segment, the respective analytical parameter and respective segment; and
obtaining a score for the respective analytical parameter and respective segment; and
associating one or more segments with each analytical parameter based on the respective score.

7. The method of claim 1, wherein generating, using the trained LLM, the response to the analytical parameter comprises:
generating the response based on the respective evaluation for the analytical parameter having a best score of the respective evaluations.

8. The method of claim 7, wherein generating, using the trained LLM, the response to the analytical parameter further comprises:
generating, using the trained LLM, a justification based on the respective evaluation for the analytical parameter having the best score of the respective evaluations; and
wherein outputting the full evaluation comprises outputting the justification.

9. The method of claim 1, wherein generating, using the trained LLM, the response to the analytical parameter comprises:
generating the response based on an averaging of the respective evaluations for the analytical parameter.

10. The method of claim 7, wherein generating, using the trained LLM, the response to the analytical parameter further comprises:
generating, using the trained LLM, a justification for each respective evaluation for the analytical parameter;
generating, using the trained LLM, a summary justification based on the generated justifications for the respective evaluation for the analytical parameters; and
wherein outputting the full evaluation comprises outputting the justification.

11. The method of claim 1, wherein generating, using the trained LLM, the response to the analytical parameter comprises:
generating the response based on the respective evaluation for the analytical parameter having a worst score of the respective evaluations.

12. The method of claim 7, wherein generating, using the trained LLM, the response to the analytical parameter further comprises:
generating, using the trained LLM, a justification based on the respective evaluation for the analytical parameter having the worst score of the respective evaluations; and
wherein outputting the full evaluation comprises outputting the justification.

13. A system comprising:
a non-transitory computer-readable medium; and
one or more processors communicatively connected to the non-transitory computer-readable medium, the one or more processors configured to execute processor-executable instructions stored in the non-transitory computer-readable medium to cause the one or more processors to:
receive a set of communication records, the set of communication records representing one or more communications between a first person and a second person;
receive a set of analytical parameters associated with the set of communication records;
generate a plurality of segments from the communication records;
for each analytical parameter in the set of analytical parameters:
determine a subset of segments semantically associated with the respective analytical parameter;
generate, using a trained large language model (“LLM”), an evaluation of each segment of the respective subset of segments with respect to the respective analytical parameter; and
generate, using the trained LLM, a response to the analytical parameter based on the evaluations of the segments; and
output a full evaluation of the set of communication records based on the set of analytical parameters and the respective generated responses to the analytical parameters.

14. The system of claim 13, wherein the one or more processors are configured to execute further processor-executable instructions stored in the non-transitory computer-readable medium to:
generate, using a trained machine learning (“ML”) model, analytical parameter embeddings for each analytical parameter of the set of analytical parameters;
generate, using the trained ML model, segment embeddings for each segment of the plurality of segments; and
wherein determining the subset of segments semantically associated with the respective analytical parameter is based on the respective analytical parameter embedding and the segment embeddings.

15. The system of claim 13, wherein the one or more processors are configured to execute further processor-executable instructions stored in the non-transitory computer-readable medium to generate, using the trained LLM, a justification associated with the response to the analytical parameter.

16. The system of claim 13, wherein the one or more processors are configured to execute further processor-executable instructions stored in the non-transitory computer-readable medium to:
generate, for each analytical parameter and associated segment of the respective subset of segments, a prompt for the LLM, the prompt comprising the analytical parameter, the segment, and an indication of an evaluation format to be generated;
provide the prompt to the LLM; and
wherein generating the respective evaluation of each segment is based on the prompt.

17. The system of claim 16, wherein the evaluation format comprises one of (a) a “yes” or “no” answer, (b) a selection from multiple choices, (c) a numerical rating, or (d) a free-form answer.

18. The system of claim 13, wherein the one or more processors are configured to execute further processor-executable instructions stored in the non-transitory computer-readable medium to:
for each analytical parameter:
for each segment:
provide, to a cross-encoder for each segment, the respective analytical parameter and respective segment; and
obtain a score for the respective analytical parameter and respective segment; and
associate one or more segments with each analytical parameter based on the respective score.

19. A non-transitory computer-readable medium comprising processor-executable instructions configured to cause one or more processors to:
receive a set of communication records, the set of communication records representing one or more communications between a first person and a second person;
receive a set of analytical parameters associated with the set of communication records;
generate a plurality of segments from the communication records;
for each analytical parameter in the set of analytical parameters:
determine a subset of segments semantically associated with the respective analytical parameter;
generate, using a trained large language model (“LLM”), an evaluation of each segment of the respective subset of segments with respect to the respective analytical parameter; and
generate, using the trained LLM, a response to the analytical parameter based on the evaluations of the segments; and
output a full evaluation of the set of communication records based on the set of analytical parameters and the respective generated responses to the analytical parameters.

20. The non-transitory computer-readable medium of claim 19, further comprising processor-executable instructions configured to cause the one or more processors to generate, using the trained LLM, a justification associated with the response to the analytical parameter.
